(19) United States
(12) Patent Application Publication
(10) Pub. No.: US 2009/0020263 A1
(43) Pub. Date: Jan. 22, 2009

(54) Cooling Apparatus for Fluid

(76) Inventors: Akihiro Ohsawa, Kanagawa (JP); Shinji Tsujimura, Kanagawa (JP); Rencai Chu, Kanagawa (JP); Hikosaburou Hiraki, Tochigi (JP)

Correspondence Address: WENDEROTH, LIND & PONACK, L.L.P., 2033 K STREET N. W., SUITE 800, WASHINGTON, DC, 20006-1021, US

(21) Appl. No.: 12/223,128

(22) PCT Filed: Jan. 24, 2007
(86) PCT No.: PCT/JP2007/051075

§ 371 Date: Jul. 23, 2008

(30) Foreign Application Priority Data
Jan. 26, 2006 (JP) 2006-017704

(51) Int. Cl. F28D 1/00; F28D 15/00; F02M 31/20

(52) U.S. Cl. 165/104.11; 165/104.34; 123/542; 165/148

(57) ABSTRACT

An apparatus for efficiently cooling the heat of a hot target without enlarging the size of a cooling device or needing either a piping to connect an evaporation portion and a condensation portion or a steam circulation pump. An exoergic-side heat exchanger has a fluid passage for the target fluid, and stores a coolant for cooling the fluid in the fluid passage through heat exchange. An endoergic-side heat exchanger has at least two coolant passages, the one ends of which communicate with the endoergic-side heat exchanger, and the other ends of which communicate with each other through a common coolant passage. A cooling device cools the coolant by exchanging heat with the coolant passing through the exoergic-side heat exchanger. The coolant passage has a diameter or an equivalent diameter within a range of 2 mm to 16 mm, and all the coolant passages have a substantially identical or equivalent diameter.

### TECHNICAL FIELD

The present invention relates to an apparatus for cooling a fluid to be cooled such as an exhaust gas and a compressed air.

### BACKGROUND ART

Recently, restriction on an exhaust gas from a diesel or gasoline engine has become tighter. Among others, regulation for NOx (nitrogen oxides) has been increasingly restricted year after year.

Conventionally, as a method for reducing the NOx, there has been implemented a method of performing recirculation of the exhaust gas emitted from the diesel or gasoline engine and returning to an intake air (Exhaust Gas Recirculation, EGR).

The EGR is a method of returning a part of the inert engine exhaust gas to the intake air of the engine to lower the combustion temperature, thereby reducing the NOx (nitrogen oxides), etc. which are hazardous components in the exhaust gas.

FIG. 1 shows a system for realizing the EGR.

As shown in FIG. 1, an exhaust air passage 2 and an intake air passage 3 in an engine 1 are communicated by way of an EGR passage 4. To the EGR passage 4, an EGR cooler 5 is provided. The EGR cooler 5 is provided to reduce the NOx without degradation in engine power by lowering the temperature of the exhausted gas (EGR gas) introduced into the EGR passage 4 from the exhaust air passage 2 to increase the charging efficiency of the intake air run into a cylinder of the engine 1.

In the engine 1, a coolant passage 6 in which a coolant passes is formed. By way of a passage 7, the coolant passage 6 is communicated with a radiator 8 for lowering a temperature of the coolant through heat exchange with outside air. A radiator cooling fan 9 is provided in the proximity to the radiator 8. The radiator cooling fan 9 blows air to the radiator to cool the coolant passing in the radiator 8. The wind caused by the radiator cooling fan 9 passes through the radiator 8 and the temperature of the wind becomes higher because it absorbs the heat from the radiator 8. After passing through the radiator 8, the wind moves to a direction opposite to the radiator cooling fan 9 with respect to the radiator 8.

Similarly, a coolant passage is also provided to the EGR cooler 5. This coolant passage is communicated with the radiator 8 by way of the passage 7. Accordingly, the coolant passing through the EGR cooler 5 is also made cool by the radiator 8.

In other words, a part of the coolant used for cooling the engine 1 is used as the coolant for the EGR cooler 5. The coolant heated through the heat exchange with the EGR gas in the EGR cooler 5 is merged with the coolant heated as a result of cooling the engine 1, and is led to the radiator 8.

The art as described above, in which a part of the engine coolant is led to the EGR cooler 5 to cool the EGR gas, is described in the background art of the Patent Literature 1.

Incidentally, a larger amount of EGR has been required to further reducing the NOx. The amount of heat required for cooling the large amount of EGR gas is increased accordingly, which necessitates a larger capacity and size of the EGR cooler 5, the radiator 8, the radiator cooling fan 9, a water pump, or other cooling units. As a result, large spaces in the engine room are required for the enlarged those cooling units for the engine, causing a heavy burden of vehicle design.

However, there exists a demand that the cooling capacity should be maintained while keeping the cooling units such as the radiator small, even if the amount of the EGR gas increases.

To respond to the demand above, the Patent Literature 1 above provides an invention for increasing the cooling efficiency without enlarging the size of the radiator, and so on through a principle of boiling and condensation. In other words, with the principle of boiling and condensation, the Patent Literature 1 describes an invention of reducing the number of the pipes connecting the evaporator with a condenser as many as possible and eliminating the need for a circulation pump by using the gravity as driving force for circulating the condensed fluid to an evaporator. In this invention, the condenser is placed above the evaporator; the condenser and the evaporator are connected with the pipes for the steam and the condensed fluid; the coolant is evaporated to the steam in the evaporator; the steam is led to the condenser placed above by way of the pipe for the steam; the steam is condensed to the fluid in the condenser; and the condensed fluid is dropped to the evaporator below by way of the pipe for the condensed fluid with the gravity. According to the invention above, it may be possible to keep the radiator and other cooling units in the existing size, and the circulation pump for circulating the steam becomes unnecessary.

The Patent Literature 2 discloses another method utilizing the principle of boiling and condensation. In this invention, the condenser is directly communicated with the evaporator placed above without using any pipe, and passages for steam and the condensed fluid are separately provided. The steam generated in the evaporator is led to the passage for steam placed above without using any pipe and the steam is moved. Thus, pressure loss caused by the steam movement is smaller than that of the invention of the Patent Literature 1. Additionally, the fluid condensed in the space located above falls through the passage for the condensed fluid without passing through the pipe, whereby the pressure loss caused by the falling can be lowered as compared with that of the invention of the Patent Literature 1. As a result, the pressure loss caused by the circulation of a medium can be reduced, whereby the medium smoothly circulates. Additionally, since the passage for stream and that for the condensed fluid are separated, it can be prevented that the falling of the condensed fluid is blocked by the steam entered into the passages for the condensed fluid, which enables the medium to be efficiently circulated. Accordingly, it is possible to improve the thermal transfer performance as compared with the art of the Patent Literature 1.

The identical point of inventions of the Patent Literatures 1 and 2 is that both of the inventions employ the gravity for circulating the medium. In the case where the gravity is used for circulating the medium, it is essential to separate the passage for the steam and that for the condensed fluid.

Additionally, another problem of the above-stated art that employs the gravity for circulating the medium is that the thermal transfer performance significantly deteriorates in a certain posture. In a case where the cooling unit is tilted, the circulation force of the condensed fluid becomes equal to the component of gravity acting parallel to a tilted surface, which results in a significant reduction in the circulation force. This causes a serious problem especially in a case of application of construction machine. The construction machine may be operated even in a slope of 30 degrees. In the technique as described above that employs the gravity as the circulation force, because of the reduction in the circulation force, the heat radiation becomes insufficient at the time when the construction machine tilts 30 degrees, whereby a temperature of the working medium rises. Accordingly, pressure of the medium suddenly increases, which may damage the EGR cooler.

### Patent Literature 1: Japanese Patent Application Laid-open No. 2003-278607

### Patent Literature 2: Japanese Patent Application Laid-open No. 08-78588

### DISCLOSURE OF THE INVENTION

### Problems to be Solved by the Invention

The benefits brought about by the use of the principle of boiling and condensation are such that pipes can be omitted; the size of the apparatus can be minimized; and the circulation pump becomes unnecessary. On the other hand, there exists a problem of significantly limiting the thermal transfer performance in a case of using the method described above, which employs the gravity for the circulation of the medium.

As another method for improving the thermal transfer performance using the principle of boiling and condensation, there has been proposed an apparatus, as shown in FIG. 2, which uses a meandering tube heat pipe 100 that employs a principle of self-excited vibration.

As shown in FIG. 2, the heat pipe 100 is formed by turning a thin tube plural times, and a heating medium is sealed in the heat pipe 100. In this method, vibrating force is utilized as driving force for circulating the heating medium, and significant improvement in the thermal transfer performance can be expected.

In the cooling apparatus utilizing the heat pipe 100, however, the heat exchange is performed while a cooling medium moves in the single thin pipe. The amount of heat transport becomes small in this apparatus because a rapid increase in the flow resistance as a result of an increase in the thermal load impedes the movement of the cooling medium, namely, the thermal movement. Thus, this apparatus is not suitable for cooling a large amount of cooling target having a high temperature, such as the exhaust gas.

The present invention has been made in view of the circumstances as described above, and the problem to be solved by the present invention is to, without enlarging the cooling units such as the radiator, eliminate the need for the pipes connecting the evaporator with the condenser as well as the circulation pump for circulating the steam; improve the thermal transfer performance by using, as the circulation force, the vibrating force rather than the gravity; and enable the large amount of heat transport from the cooling target having a high temperature such as the exhaust gas.

### Means to Solve the Problems

A first aspect of the present invention provides a cooling apparatus for a fluid, which includes: an endoergic-side heat exchanger that has a fluid passage for passing a fluid to be cooled and stores a cooling medium for cooling the fluid through heat exchange with the fluid in the fluid passage; an exoergic-side heat exchanger that has at least two cooling medium passages, one ends of the at least two cooling medium passages being communicated with the endoergic-side heat exchanger and the other ends of the at least two cooling medium passages being communicated with each other; and cooling means that cools the cooling medium passing in the exoergic-side heat exchanger through heat exchange with the cooling medium, in which the cooling apparatus is configured so as to recirculate the cooling medium between the endoergic-side heat exchanger and the exoergic-side heat exchanger, the cooling medium passages have a passage diameter or a equivalent diameter ranging from 2 mm to 16 mm inclusive, and the entire cooling medium passage is formed with a substantially equal diameter or the equivalent diameter.

A second aspect of the present invention provides the cooling apparatus for the fluid according to the first aspect of the invention, in which an EGR passage that supplies an exhaust gas in an engine exhaust passage to an intake passage is provided, and the exhaust gas passing through the EGR passage passes through the endoergic-side heat exchanger.

A third aspect of the present invention provides the cooling apparatus for the fluid according to the first aspect of the invention, in which a turbocharger that compresses an intake air and introduces the compressed intake air to an engine intake passage is provided, and the intake air compressed by the turbocharger passes through the endoergic-side heat exchanger as the fluid to be cooled.

A fourth aspect of the present invention provides the cooling apparatus for the fluid according to any one of the first through third aspects of the invention, in which the cooling means is a cooling fan.

A fifth aspect of the present invention provides the cooling apparatus for the fluid according to the fourth aspect of the invention, which further includes: a radiator through which an engine coolant passes; and a radiator cooling fan, in which the radiator cooling fan is employed as the cooling means.

A sixth aspect of the present invention provides the cooling apparatus for the fluid according to the first aspect of the invention, in which a ratio of the volume of the cooling medium to the volume of the endoergic-side heat exchanger and the exoergic-side heat exchanger is set to a prescribed volume ratio ranging from 20% to 80% inclusive.

A seventh aspect of the present invention provides a cooling apparatus for a fluid, in which the cooling apparatus for the fluid according to the first aspect of the invention includes: plural separate endoergic-side heat exchangers; plural separate exoergic-side heat exchangers each corresponding to the plural separate endoergic-side heat exchangers, in which the fluid passages in the plural separate endoergic-side heat exchangers are each communicated in series, and a boiling point of the cooling medium in each of the plurality of separate endoergic-side heat exchangers is set so as to gradually decrease as a position of the fluid passage goes from an upper stream to a down stream.

An eighth aspect of the present invention provides the cooling apparatus for the fluid according to the seventh aspect of the invention, in which each of the plural separate endoergic-side heat exchangers is divided by a partition that allows the fluid to be cooled to pass to the adjoining endoergic-side heat exchangers and does not allow the cooling medium to pass to the adjoining endoergic-side heat exchanger.

A ninth aspect of the present invention provides the cooling apparatus for the fluid according to the fourth aspect of the invention, which further includes: a radiator through which an engine coolant passes; and a radiator cooling fan, in which the cooling fan is separately provided as the cooling medium in addition to the radiator cooling fan.

A tenth aspect of the present invention provides the cooling apparatus for the fluid according to the fourth aspect of the invention, in which the exoergic-side heat exchanger is formed in an annular shape, and the cooling fan is arranged as the cooling means inside the exoergic-side heat exchanger formed in the annular shape.

An eleventh aspect of the present invention provides the cooling apparatus for the fluid according to the tenth aspect of the invention, in which the cooling apparatus is placed above the engine.

A twelfth aspect of the present invention provides the cooling apparatus for a fluid, which includes: an endoergic-side heat exchanger that has a fluid passage for passing a fluid to be cooled and stores a cooling medium for cooling the fluid through heat exchange with the fluid in the fluid passage; an exoergic-side heat exchanger that has at least two cooling medium passages, one ends of the at least two cooling medium passages being communicated with the endoergic-side heat exchanger and the other ends of the at least two cooling medium passages being communicated with each other; and cooling means that cools the cooling medium passing in the exoergic-side heat exchanger through heat exchange with the cooling medium, in which the cooling apparatus is configured so as to recirculate the cooling medium between the endoergic-side heat exchanger and the exoergic-side heat exchanger, and the cooling medium passages are capable of passing steam in which the cooling medium is vaporized in the endoergic-side heat exchanger by absorbing heat of the fluid, and the cooling medium that becomes liquid in the exoergic-side heat exchanger after heat is absorbed with the cooling means.

### EFFECTS OF THE INVENTION

The cooling apparatus of the present invention has at least two passages for a cooling medium. Other ends of the two passages for the cooling medium are communicated with each other, and both of the cooling medium passages have a substantially equal diameter or an equivalent diameter. By setting the diameter or the equivalent diameter of the cooling medium passages to 2 mm to 16 mm, it becomes possible to cause the self-excited vibration. The equivalent diameter herein refers to a diameter in which the fluid resistances of the passages are equal in a case when the cross section of the cooling medium passage that does not have a round shape is represented by the round shape.

In the present invention, both the steam vaporized after absorbing the heat of the fluid in an endoergic-side heat exchanger and the cooling medium liquefied in an exoergic-side heat exchanger can be passed through the at least two cooling medium passages. This enables a reduction in the fluid resistance. Thus, the condensed fluid is refluxed faster than that only by the gravity, whereby the amount of heat transport can be increased several times.

In the present invention, since the vibrating force is used as the driving force for circulating the cooling medium, it is unlikely to be affected by the gravity. Thus, deterioration of the thermal transfer performance can be prevented even in the tilted situation.

In the present invention, a passage for the fluid (exhaust gas) is formed within the endoergic-side heat exchanger. Thus, an endoergic area between the fluid (exhaust gas) and the cooling medium becomes large. This enables the significant increase in the amount of heat input. Therefore, the amount of heat transport becomes large, whereby the large amount of heat from the cooling target having a high temperature such as the EGR gas can be efficiently cooled.

### BEST MODE FOR CARRYING OUT THE INVENTION

Referring now to drawings, an embodiment of a cooling apparatus for a fluid according to the present invention will be described.

FIG. 3 shows a layout of an engine room of a construction machine of an embodiment.

As shown in FIG. 3, an exhaust air passage 2 and an intake air passage 3 in an engine 1 are communicated by way of an EGR passage 4.

To the EGR passage 4, an EGR cooler 15 is provided. In the EGR passage 4, an EGR gas 30, which is a cooling target of the EGR cooler 15, is introduced from the exhaust air passage 2 and the EGR gas 30 passes. The EGR cooler 15 is a cooling apparatus for cooling the EGR gas 30 to be cooled, and is provided for the purpose of reducing the NOx and so on without degradation in engine power by lowering the temperature of the EGR gas 30 flowing into the intake passage 3 through the EGR passage 4 to increase the charging efficiency of a gas run into a cylinder of the engine 1.

In the engine 1, a coolant passage 6 for passing a coolant is formed. By way of a passage 7, the coolant passage 6 is communicated with a radiator 8 for lowering the temperature of the coolant through heat exchange with outside air. Generally, the temperature of the coolant is about 80 degrees Celsius. A radiator cooling fan 9 is provided in the proximity to the radiator 8. The radiator cooling fan 9 blows air from the outside to the radiator 8 to cool the coolant passing in the radiator 8. The cooling air blown to the radiator 8 is about 30 degrees Celsius. After passing through the radiator 8, the air directs to the EGR cooler 15 as cooling air 21 having a high temperature of about 70 degrees Celsius.

FIGS. 4A and 4B show a configuration of the EGR cooler 15.

FIG. 4A is a perspective view of the EGR cooler 15. FIG. 4B shows a sectional view taken from line A-A of FIG. 4A.

As shown in FIGS. 4A and 4B, the EGR cooler 15 includes an endoergic-side heat exchanger (boiling section or evaporating section; evaporator) 16 and an exoergic-side heat exchanger (condensing section; condenser) 17.

In this embodiment, the EGR gas 30 flowing in the EGR passage 4 passes within the endoergic-side heat exchanger 16.

A cooling medium storage reservoir 18 is formed in the endoergic-side heat exchanger 16 so as to surround the EGR passage 4.

Inside the endoergic-side heat exchanger 16, the EGR passage 4 is divided into plural EGR passages 4a, 4a, . . . as shown in FIG. 4B. Inside the endoergic-side heat exchanger 16, the cooling medium storage reservoir 18 is formed so as to surround the plural EGR passages 4a, 4a, . . . . To the cooling medium storage reservoir 18, a cooling medium 20 for cooling the EGR gas 30 through heat exchange with the EGR gas 30 contained in each of the plural EGR passages 4a, 4a, . . . is stored. Additionally, fins 4b, 4b, . . . are provided to each of the plural EGR passages 4a, 4a, . . . . As described above, since the cooling medium storage reservoir 18 is formed so as to surround the plural EGR passages 4a, 4a, . . . , and the fins 4b, 4b, . . . are provided, the area where the cooling medium 20 contacts with an outer surface of the EGR passage 4 can be large. This enables a large heating surface area between the EGR gas 30 and the cooling medium 20, thereby realizing efficient heat exchange.

It should be noted that, as a method for making the heating surface area large, plural tubes may be provided in the EGR passage as shown in FIG. 4B.

The exoergic-side heat exchanger 17 is provided with three cooling medium passages 19, 19, 19. For the cooling medium passages 19, a tube may be employed as shown in FIGS. 4A and 4B. As an example of the tube above, a thin tube made of aluminum or copper can be given, but the tube is not limited to this example. One ends of those cooling medium passages 19, in other words, lower ends of those cooling medium passages 19 are communicated with the cooling medium storage reservoir 18 in the endoergic-side heat exchanger 16. On the other hand, other ends of those cooling medium passages 19, in other words, upper ends of those cooling medium passages 19 are communicated with each other with a common cooling medium passage 19a.

To the outer surfaces of both the cooling medium passages 19 and the common cooling medium passage 19a, fins 23 are formed for the purpose of the heat exchange with the outer air.

The cooling air 21 passing through the radiator 8 and having a high temperature of about 70 degrees Celsius flows into a cooling-air-flowing surface 17A of the exoergic-side heat exchanger 17. Then, the heat exchange is performed between the cooling air 21 and the cooling medium 20 in the cooling medium passages 19 and the common cooling medium passage 19a by way of the fins 23.

Operation in the EGR cooler 15 of this embodiment as described above will be described.

As shown in FIG. 4B, the cooling medium 20 in the cooling medium storage reservoir 18 in the endoergic-side heat exchanger 16 receives heat from the EGR gas 30 flowing in the divided EGR passages 4a, 4a, 4a . . . , and then the cooling medium steam 20G randomly occurs through phase change. This steam accumulates in the upper part of the endoergic-side heat exchanger 16. At this time, due to a rapid expansion of the volume of the cooling medium 20, the pressure increases in the endoergic-side heat exchanger 16. On the other hand, in the exoergic-side heat exchanger 17, as the cooling medium steam 20G condenses into a liquid phase due to the cooling effect with the cooling air, and its volume is reduced, the pressure locally decreases. To cancel this local pressure difference, the cooling medium steam 20G occurring in the endoergic-side heat exchanger 16 flows into each of the cooling medium passages 19 in the exoergic-side heat exchanger 17. The cooling medium passages 19, 19, 19 are communicated with each other by way of the common cooling medium passage 19a. Thus, as the cooling medium 20 in any of the cooling medium passages 19 moves upward, the cooling medium 20 in other cooling medium passage 19 moves downward accordingly. The cooling medium 20 returned to the endoergic-side heat exchanger 16 and the excess steam 20G are separated into gas and liquid. Then, the cooling medium 20 is heated again while the cooling medium steam 20G together with newly generated cooling medium steam 20G flows into the exoergic-side heat exchanger 17 due to the local pressure difference as stated above. As described above, in the endoergic-side heat exchanger 16 and each of the cooling medium passages 19, due to the local pressure difference changing randomly with time, in other words, self-excited vibration, the cooling medium 20 and the cooling medium steam 20G self-excitedly vibrates in each of the cooling medium passages 19 in the exoergic-side heat exchanger 17 and in the common cooling medium passage 19a as shown by an arrow.

Through the operation above, both latent heat of a vapor phase and sensible heat of a liquid phase are transported simultaneously.

Next, conditions for causing the self-excited vibration will be described.

As the first condition, a diameter d of each of the cooling medium passages 19 will be described.

FIG. 6B shows a relationship between the diameter d and a thermal load e.

The thermal load e is equivalent to the amount of heat transport, and may also be referred to as a thermal transfer performance.

In an experiment, to obtain the thermal load e, a length of each of the cooling medium passages 19 is set to 200 mm, while the diameter d of the cooling medium passage 19 varies ranging from 10 mm to 20 mm. In the conventional art in which the self-excited vibration does not occur, it is known that the thermal load e is about 0.3. Considering that the amount of heat transport equals to the thermal load e, it is understood from the experimental result that it may be possible to obtain 2-3.3 times increase in the amount of heat transport as compared with the conventional art by setting the equivalent diameter of each of the cooling medium passages to 2 mm-16 mm. Especially, by setting the equivalent diameter from 3 mm-13 mm, the amount of heat transport becomes 0.8 or over, and better efficiency can be obtained. As the second condition, a method for controlling the volume of cooling air to cause the self-excited vibration will be described.

FIG. 6C shows a measurement result of a relationship between the volume of cooling air and the thermal load e in the embodiment described above. As can be understood from this graph, there exists a volume of cooling air in which the thermal load becomes about the maximum value. In this case, by controlling the number of revolutions of the cooling fan such that the volume of cooling air becomes approximately 50% of the maximum air volume, it becomes possible to deal with the maximum thermal load.

As described above, in this embodiment, the cooling medium is circulated by the self-excited vibration. Since the vibrating force by the self-excitation is employed as the driving force for circulating the cooling medium 20, it is unlikely to be affected by the gravity. Thus, unlike the conventional art, the thermal transfer performance is less likely to be limited.

Additionally, the heat exchange is performed not by using the single thin tube as described with the heat pipe 100 in FIG. 2, but by forming the passages 4a for the exhaust gas 30 within the endoergic-side heat exchanger 16 and forming the cooling medium storage reservoir 18 so as to surround the passages 4a. Thus, the heating surface area between the exhaust gas 30 and the cooling medium 20 becomes large, thereby significantly improving the amount of heat input. This enables the increase in the amount of heat transport, whereby the large amount of the heat can be efficiently cooled even in a case of the cooling target having a high temperature such as the exhaust gas 30.

Next, description that, with the present invention, the size of the radiator or other cooling units remains unchanged from the existing size, and enlargement is not necessary will be made.

In the conventional art as shown in FIG. 1, an engine coolant whose temperature rises as a result of cooling the EGR gas flows into the radiator at about 80 degrees Celsius, and is cooled with the cooled air at about 30 degrees Celsius delivered by the cooling fan. In this case, the temperature difference (air-water temperature difference) between the engine coolant and the cooling air is about 50 degrees Celsius. Utilizing this temperature difference, the engine coolant is cooled.

The cooling air 21 after passing through the radiator 8 reaches a high temperature of about 70 degrees Celsius. Thus, since the air-water temperature difference for cooling the engine coolant is only about 10 degrees Celsius, the coolant is hardly cooled by the engine coolant having 80 degrees Celsius.

Incidentally, since the principle of boiling and condensation is employed in the cooling apparatus (EGR cooler 15) of the present invention, the cooling medium 20 boils. For example, when water is used as the cooling medium, the water boils at 100 degrees Celsius under a pressure of 1 atmosphere, and at 150 degrees Celsius under an internal pressure of 5 atmospheres. As the cooling medium 20 circulates forcedly by the self-excited vibration, the cooling medium 20 in the exoergic-side heat exchanger boils at the same temperature as in the endoergic-side heat exchanger, for example, 150 degrees Celsius.

Accordingly, since the exoergic-side heat exchanger of the EGR cooler 15 of the present invention reaches 150 degrees Celsius although the temperature of the cooling air 21 after passing through the radiator 8 is 70 degrees Celsius, it becomes possible to obtain the air-water temperature difference of 80 degrees Celsius. In the conventional art, even if the cooling air has a temperature of 30 degrees Celsius, the air-water temperature difference reaches as few as 50 degrees Celsius. On the other hand, the EGR cooler of the present invention can achieve the cooling capacity of 1.6 times higher than that of the conventional art, even by using the air having 70 degrees Celsius after passing through the radiator, which is treated as the air having no cooling capacity, namely wasted air in the conventional art.

As a result, the existing radiator or other cooling apparatuses can be used without changing, and the enlargement is not necessary.

Additionally, the EGR cooler 15 of this embodiment has a configuration in which the exoergic-side heat exchanger 17 is directly communicated with the endoergic-side heat exchanger 16, and the self-excited vibration, rather than the gravity, is employed to circulate the cooling medium 20. Thus, the pipes connecting the evaporator (endoergic-side heat exchanger 16) with the condenser (exoergic-side heat exchanger 17) and the circulation pump for circulating the steam becomes unnecessary.

FIGS. 5A and 5B show an example of a configuration of an EGR cooler 15 having a different appearance configuration from the EGR cooler 15 shown in FIG. 4. In FIGS. 5A and 5B, components having identical features with the components forming the EGR cooler 15 shown in FIG. 4 are denoted with identical reference numerals. As shown in FIGS. 5A and 5B, the configuration of the endoergic-side heat exchanger 16 is different from that shown in FIG. 4, and is formed in a cylindrical shape in which the EGR passage 4 (each divided EGR passages 4a) is included.

The exoergic-side heat exchanger 17 is formed in a rectangular shape. The EGR cooler 15 shown in FIGS. 5A and 5B has a configuration in which cooling medium passages 19, 19, . . . are arranged along the longitudinal direction of the EGR passage 4, whereby the exoergic-side heat exchanger 17 is formed in a thin width W.

FIGS. 7A and 7B shows a positional relationship between the radiator 8 and the radiator cooling fan 9.

The description above has been made by giving an example of the EGR gas as the fluid to be cooled. However, the fluid in the present invention is not limited to the EGR gas.

A case where engine oil is employed to the fluid to be cooled will be described.

An oil cooler 40 used for the engine and the work equipment is arranged in parallel with the radiator 8, which is not shown in FIG. 3. FIG. 5C is a schematic view of the oil cooler 40. The structure of the oil cooler 40 is similar to that of the radiator 8. Although the engine coolant passes in the radiator, the oil passes in the oil cooler 40. Since strengthening the entire oil cooler is required to prevent the oil leakage and so on because of the high oil pressure, the main difference is that the weight is heavier and the manufacturing cost are higher than that for the radiator.

By passing the oil in the fluid passage (corresponding to the passage for the EGR gas in the EGR cooler), which is the cooling target, in the endoergic-side heat exchanger having the structure of the EGR cooler shown as the example in FIGS. 5A and 5B, it can be used as the oil cooler. In this case, since a portion through which the oil passes can be reduced to ⅓ level as compared with the conventional oil cooler, a portion requiring the high strength structure can be reduced to ⅓ level from the conventional type, whereby a light and inexpensive oil cooler can be realized.

As the next embodiment, a case where the intake air compressed by a turbocharger is used as the cooling target will be described.

In FIG. 3, a turbocharger 10 is provided to the engine 1. The turbocharger 10 is provided for the purpose of improving the fuel efficiency, the power of the engine and so on. An inlet of a shroud for a turbine 11 of the turbocharger 10 is communicated with the exhaust air passage 2, while an outlet of the shroud for the turbine 11 is communicated with the outside air through a muffler 22. An inlet of a shroud for a compressor 12 of the turbocharger 10 is communicated with the outside air through an air cleaner 13, while an outlet of the shroud for the compressor 12 communicated with the intake air passage 3 through an aftercooler 14. The aftercooler 14 is provided for the purpose of decreasing the temperature of the intake air compressed by the turbocharger 10 to improve the charging efficiency of oxygen in the cylinder of the engine 1.

It may be possible to apply the present invention to the aftercooler. FIG. 5D shows a schematic view of the aftercooler. By passing the intake air compressed by the turbocharger 10 in the fluid passages, which are the cooling target of the endoergic-side heat exchanger 16, it may be possible to be used as the aftercooler. The intake air compressed by the turbocharger 10 reaches 150 degrees Celsius under a pressure of 3 atmospheres, which is relatively high temperature and high pressure. However, by applying the technique above, since the portion subjected to the high temperature and pressure can be reduced to about ⅓, the aftercooler can be made light and inexpensive as is the case with the previous embodiment above.

FIG. 6A shows a relationship between the amount of heat transport C and a volume ratio B of the cooling medium 20 in a liquid phase state to the total volume of the endoergic-side heat exchanger 16 and the exoergic-side heat exchanger 17, in other words, the total volume of the cooling medium storage reservoir 18, the cooling medium passages 19, 19, . . . and the common cooling medium passage 19a.

As shown in FIG. 6A, under the range of the volume ratio B from 20% to 80% inclusive, the amount of heat transport C becomes a sufficient level or higher to cool the high temperature exhaust gas 30. Thus, it is preferable that the volume ratio B of the cooling medium 20 is set to the range from 20% to 80% inclusive.

FIGS. 7A and 7B show positional relationships between the radiator 8 and the radiator-cooling fan 9.

In FIG. 7A, the radiator 8 is placed in a rear direction of the radiator-cooling fan 9, and the EGR cooler 15 is placed in a rear direction of the radiator 8. With the radiator-cooling fan 9, the cooling air 21 is delivered to and passed through the radiator 8; and the cooling medium 20 or the cooling medium steam 20G in the exoergic-side heat exchanger 17 of the EGR cooler 15 is cooled by the cooling air 21 having the high temperature emitted backward from the radiator 8.

Additionally, in FIG. 7B, the EGR cooler 15 is placed in a rear direction of the radiator 8, and the radiator cooling fan 9 is placed in a rear direction of the EGR cooler 15. By drawing the front air with the radiator-cooling fan 9, the cooling air 21 is delivered to and passed through the radiator 8; and the cooling medium 20 in the exoergic-side heat exchanger 17 of the EGR cooler 15 is cooled by the cooling air 21 having the high temperature emitted backward from the radiator 8.

In the embodiments above, as the means for cooling the EGR cooler 15, the radiator-cooling fan 9 for cooling the coolant of the engine 1 is employed. However, any cooling means may be employed as the cooling means for cooling the EGR cooler 15. For example, in addition to the radiator-cooling fan 9, a cooling fan dedicated to delivering the cooling air 21 to the EGR cooler 15 may be provided.

With reference to FIG. 8, an embodiment according to the configuration above will be described.

In FIG. 8, the exoergic-side heat exchanger 17 is formed in an annular shape.

FIG. 8A is a perspective view of the EGR cooler 15, and FIG. 8B shows a sectional view taken from line B-B along the circle of the EGR cooler 15 shown in FIG. 8A. Components having identical features with the components forming the EGR cooler 15 shown in FIG. 4 are denoted with identical reference numerals.

In FIG. 8, the exoergic-side heat exchanger 17 is formed in an annular shape. However, it may be possible to form in a polygonal and annular shape.

In the EGR cooler 15 according to this embodiment, an annular-shaped cooling fan 24 is similarly provided inside the annular-shaped exoergic-side heat exchanger 17 as the cooling means. The cooling fan 24 is provided in addition to the radiator-cooling fan 9. The cooling fan 24 pulls the outside air from above (or from an outer wall surface 17B), and the cooling air 21 is delivered to each part of an inner wall surface 17A of the annular-shaped exoergic-side heat exchanger 17. The cooling air 21 passing through the annular-shaped exoergic-side heat exchanger 17 is discharged from the outer wall surface 17B (or from above).

In the apparatus according to this embodiment, in addition to the radiator-cooling fan 9, the cooling fan 24 dedicated to the EGR cooler 15 is provided. Thus, it becomes possible to place the EGR cooler 15 in this embodiment in the proximity of the EGR passage 4 without any locational restriction with respect to the radiator-cooling fan 9.

As is the case with FIG. 8B, FIG. 8C shows a sectional view taken from line B-B along the circle of the EGR cooler 15 shown in FIG. 8A.

The endoergic-side heat exchanger 16 includes plural separate endoergic-side heat exchangers 16A, 16A, 16A, each of which has a separate cooling medium storage reservoir 18A, 18A, 18A. Additionally, the exoergic-side heat exchanger 17 includes plural separate exoergic-side heat exchangers 17A, 17A, 17A, each of which corresponds to each of the plural separate endoergic-side heat exchangers 16A, 16A, 16A. Each of the endoergic-side heat exchangers 16A, 16A, 16A is separated by partitions 16B, 16B that allow the EGR gas 30 to flow in the adjoining endoergic-side heat exchanger 16A and that do not allow the cooling medium 20 to flow in the adjoining endoergic-side heat exchanger 16A.

EGR passages 4c, 4c, 4c in the endoergic-side heat exchangers 16A, 16A, 16A are communicated in series with each other, and forms the EGR passage 4.

The boiling points of the cooling mediums 20 in the cooling medium storage reservoirs 18A, 18A, 18A in the endoergic-side heat exchangers 16A, 16A, 16A are respectively set to the temperatures T1, T2, T3, which gradually decrease (T1>T2>T3) as a position goes from an upper stream to a down stream in the EGR passages 4c, 4c, 4c.

FIGS. 10A and 10B show schematic diagrams each illustrating a case where a single EGR cooler 15 is provided to the EGR passage 4 and a case where plural (two) EGR coolers 15 are provided in series, and show the comparison of the cooling capacity.

Firstly, as shown in FIG. 10A, the case where the single EGR cooler 15 is provided to the EGR passage 4 will be described.

By setting the boiling point of the cooling medium 20 in the cooling medium storage reservoir 18 to 140 degrees Celsius, the EGR gas 30 flowing into the intake of the EGR cooler 15 at 540 degrees Celsius is cooled, and flows out from the EGR cooler 15 at 165 degrees Celsius. It should be noted that it is assumed that the temperature of the cooling air 21 is 70 degrees Celsius.

On the other hand, as shown in FIG. 10B, the case where plural (two) EGR coolers 15 are provided in series will be described. It is assumed that the boiling point T1 of the cooling medium 20 in the cooling medium storage reservoir 18 located in the upper stream side of the EGR cooler 15 of the EGR passage 4 is set to 180 degrees Celsius; the boiling point T2 of the cooling medium 20 in the cooling medium storage reservoir 18 located in the down stream side of the EGR cooler 15 of the EGR passage 4 is set to 110 degrees Celsius; and the temperature of the EGR gas 30 at the entrance of the upper stream side of the EGR cooler 15 is set to 540 degrees Celsius, which is the same temperature as that shown in FIG. 10A. The EGR gas flowing in at 540 degrees Celsius is cooled in the upper stream side and the down stream side of the EGR coolers 15, and flows out from the lower stream side of the EGR cooler at the temperature of 150 degrees Celsius. This enables a further decrease in the temperature of the EGR gas 30 as compared with the configuration as shown in FIG. 10A.

In general, between the number N of stages at which the endoergic-side heat exchangers 16A are connected in series and the temperature of the EGR gas 30 at the outlet of the EGR cooler 15, there exists a relationship that, as the number N of stages at which the endoergic-side heat exchangers 16A are connected in series increases, the cooling capacity is improved while the temperature of the EGR gas 30 at the outlet of the EGR cooler 15 becomes lower. Thus, although FIG. 10B illustrates the case where the endoergic-side heat exchangers 16A are connected in series at two stages, the temperature of the EGR gas 30 may be further lowered by increasing the stage number of the endoergic-side heat exchanger 16A in series connection to three stages or over, in other words, to multiple stages.

The relationship above is valid even in a case where the plural EGR coolers 15 each formed by one single integrated unit are connected in series along the EGR passage 4 while the endoergic-side heat exchangers 16A, 16A, . . . are connected in series as shown in FIG. 10B, or even in a case where the partition 16B is provided in the EGR cooler 15 formed by one single integrated unit while the endoergic-side heat exchangers 16A, 16A, . . . are connected in series as shown in FIG. 8C. In other words, in the configuration as shown in FIG. 8C, the cooling capacity can be improved as the stage number N of the endoergic-side heat exchangers 16A in series connection goes up by increasing the number of the partition 16B. This enables the further decrease in the outlet temperature of the EGR gas 30.

It should be noted that, in the embodiments above, the EGR 15 having a configuration in which the exoergic-side heat exchanger 17 is placed higher than the endoergic-side heat exchanger 16 has been described as examples. However, since the present invention employs the self-excited vibration to circulate the cooling medium 20, the exoergic-side heat exchanger 17 is not necessarily required to be placed in a higher position than the endoergic-side heat exchanger 16. As shown in FIG. 11, for example, it may be possible to form the EGR cooler 15 in a configuration in which a part of the exoergic-side heat exchanger 17 is placed in a lower position than the endoergic-side heat exchanger 16.

FIG. 9 shows an example of arrangement of the EGR cooler 15 shown in FIG. 8. In FIG. 9, the EGR cooler shown in FIG. 8 is placed above the engine. Components having identical features with the components forming the engine 1 and its auxiliary units shown in FIG. 3 are denoted with identical reference numerals.

In a case where the EGR cooler 15 is placed above the engine 1 as described above, the EGR cooler 15 is located near the existing EGR passage 4 as compared with the case where the EGR cooler 15 is placed in front of or at back of the radiator 8 as illustrated in the embodiment shown in FIGS. 7A and 7B. Thus, the EGR cooler 15 can be provided without considerable modification such as extending the pipes from the existing EGR passage 4. For example, the system may be formed only by equipping the existing EGR passage 4 above the engine 1 with a bolt-on EGR cooler 15 from another unit.

### BRIEF DESCRIPTION OF THE DRAWINGS

FIG. 1 is a diagram illustrating the conventional art and showing a configuration of an EGR cooler for cooling;

FIG. 2 is a diagram illustrating the conventional art and showing a configuration of a heat pipe using self-excited vibration;

FIG. 3 is a diagram illustrating a relationship between an EGR cooler in the embodiment and other components;

FIGS. 4A and 4B are diagrams illustrating a configuration of the EGR cooler in the embodiment;

FIGS. 5A through 5D are diagrams illustrating configurations of EGR coolers different from the EGR cooler as shown in FIGS. 4A and 4B;

FIGS. 6A through 6C are graphs showing experimental data in connection with the EGR cooler in the embodiment;

FIGS. 7A and 7B are diagrams showing examples of positional relationships among the EGR cooler, a radiator and a radiator cooling fan shown in FIG. 6;

FIGS. 8A through 8C are configurational diagrams of an EGR cooler having configurations different from the EGR cooler as shown in FIGS. 4A and 4B, the EGR cooler being provided with a dedicated cooling fan;

FIG. 9 is a layout diagram showing a positional relationship between an engine and the EGR cooler shown in FIG. 8;

FIGS. 10A and 10B are diagrams explaining the cooling capacity with comparison; and

FIG. 11 is an example diagram showing an appearance configuration of the EGR cooler.

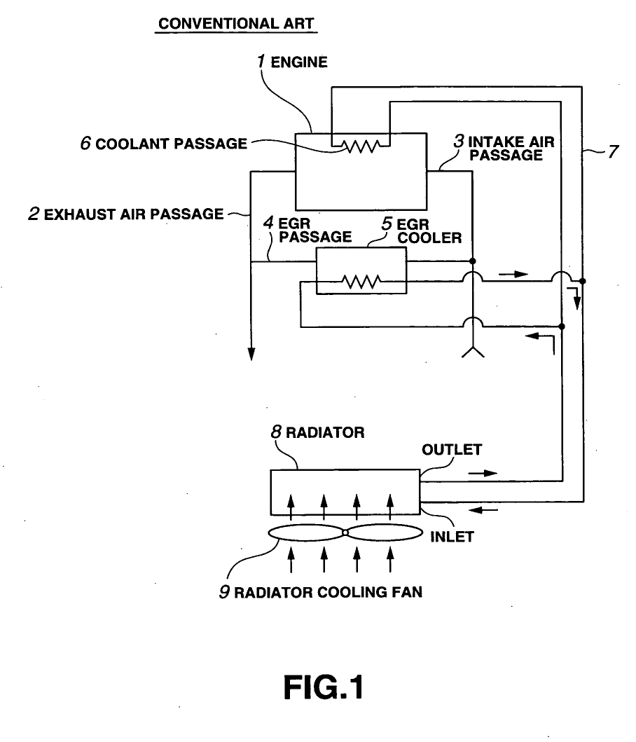

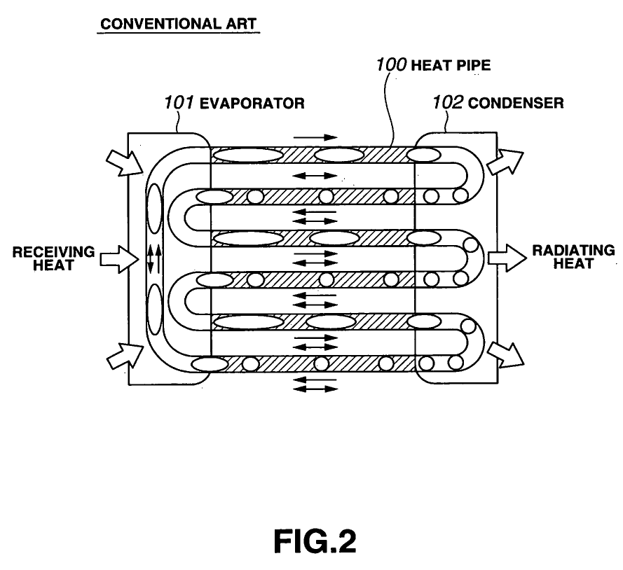

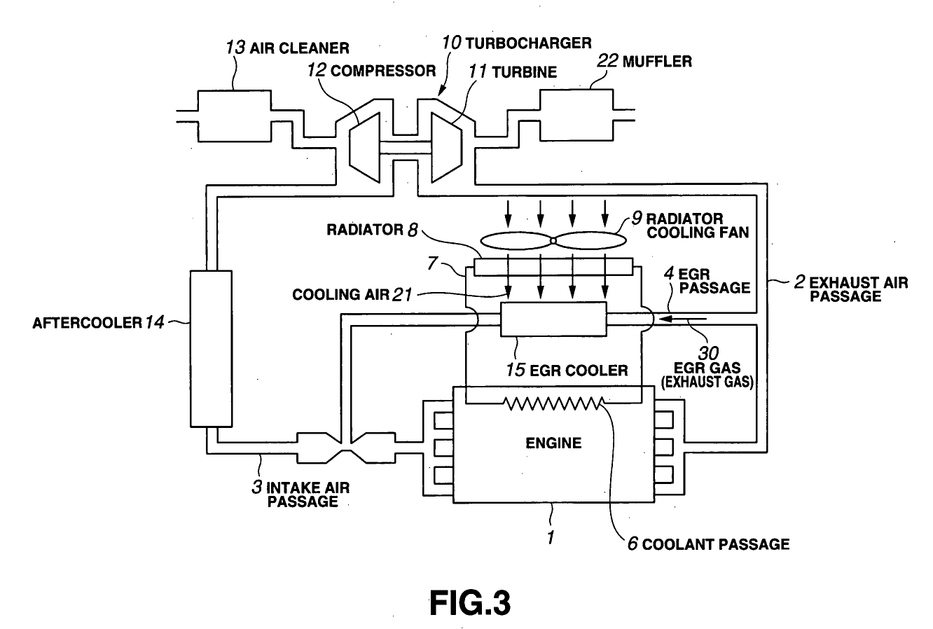

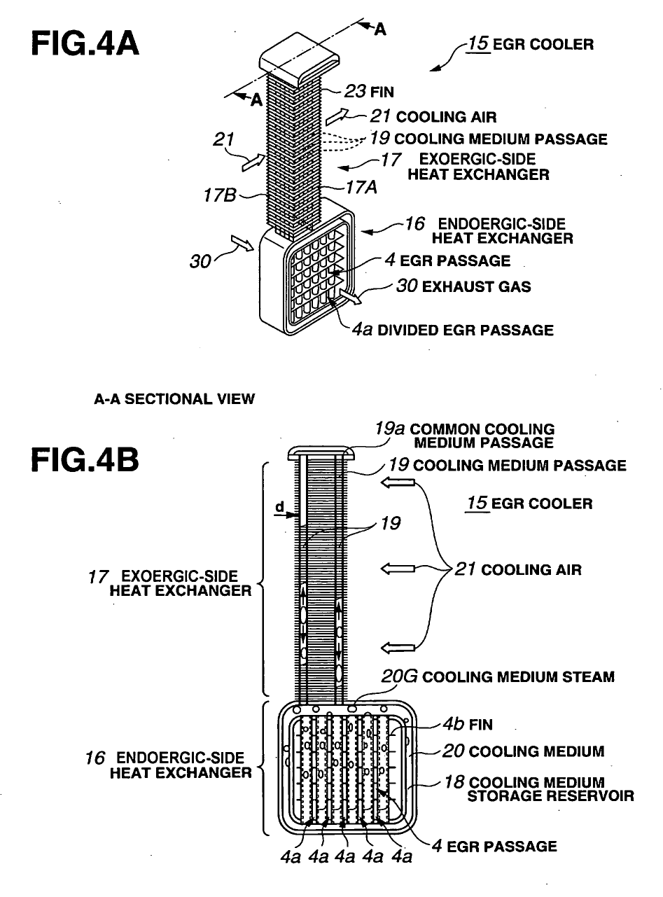

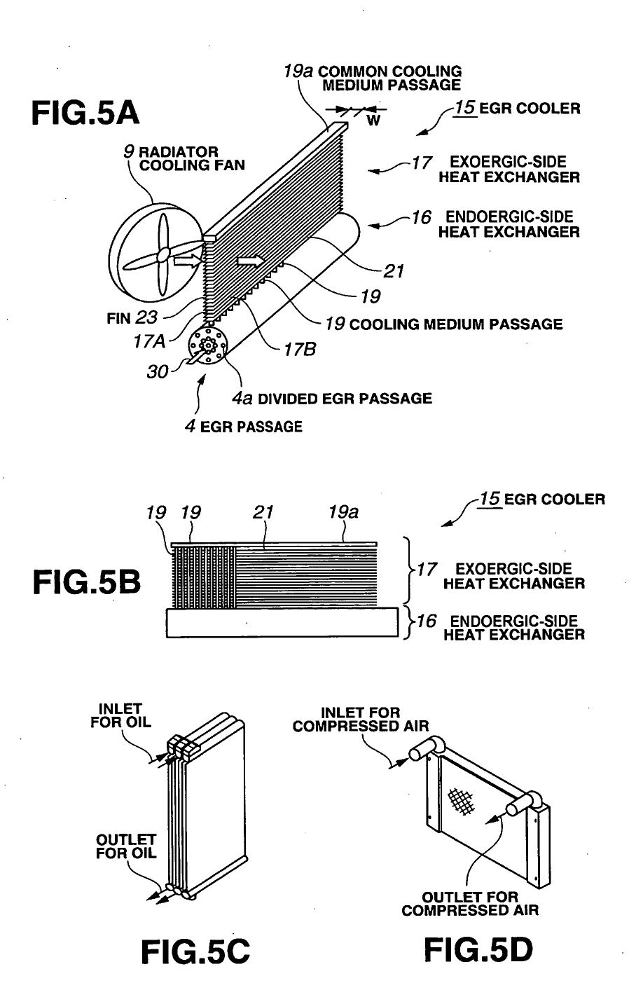

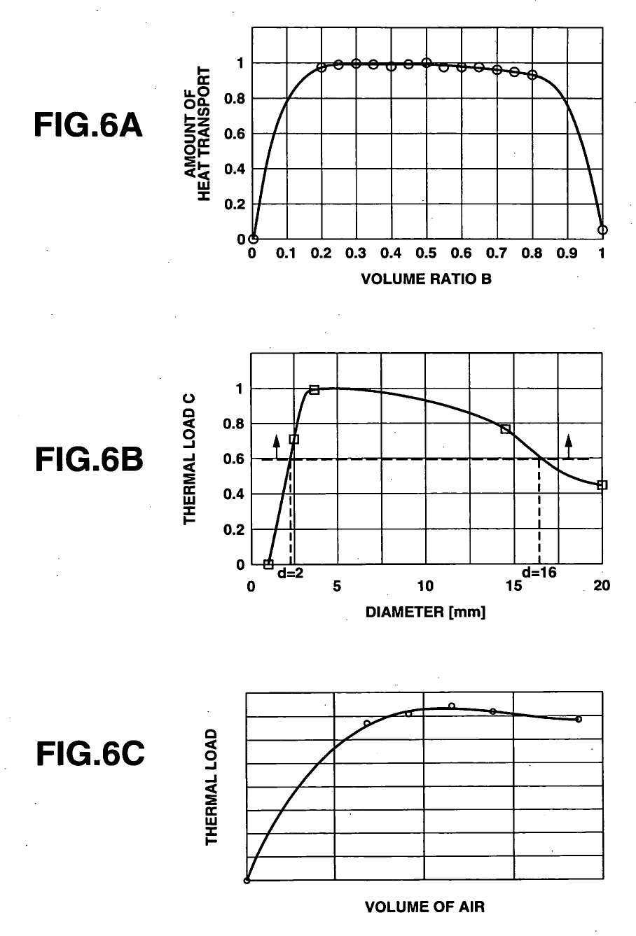

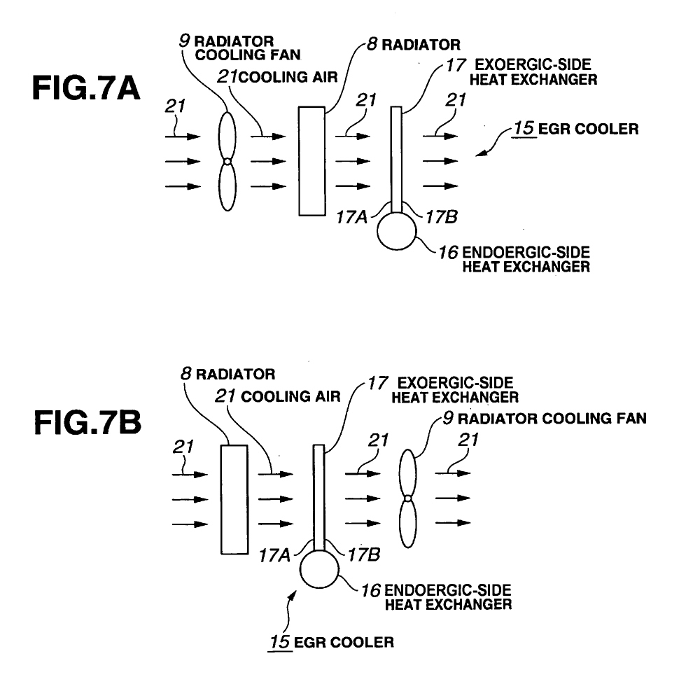

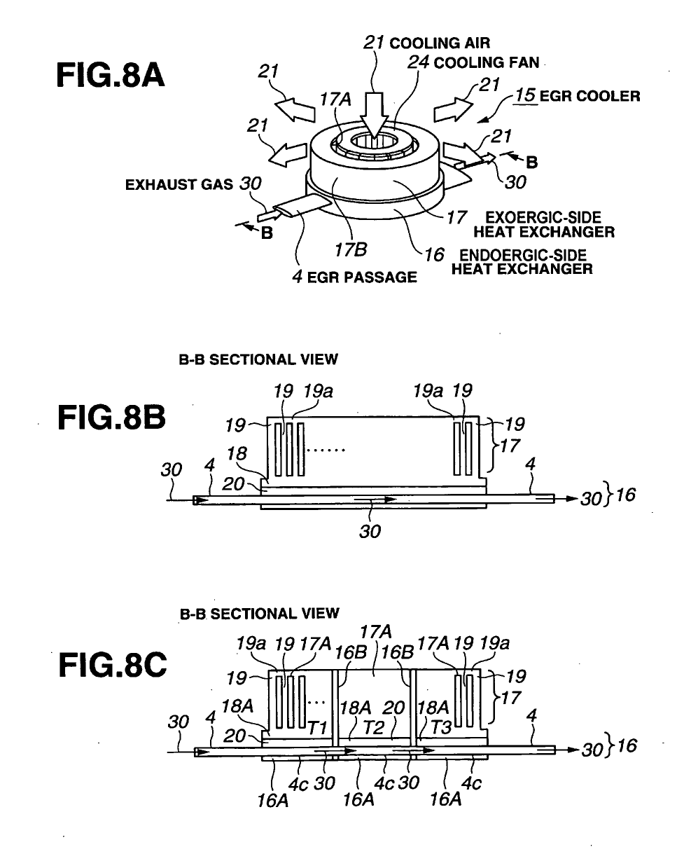

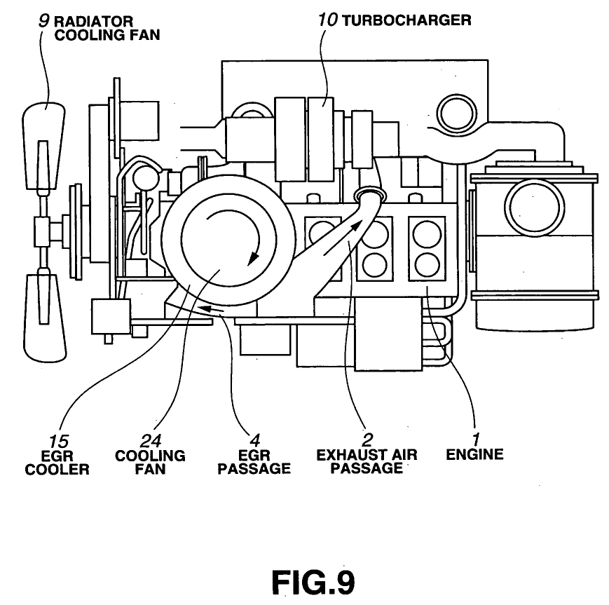

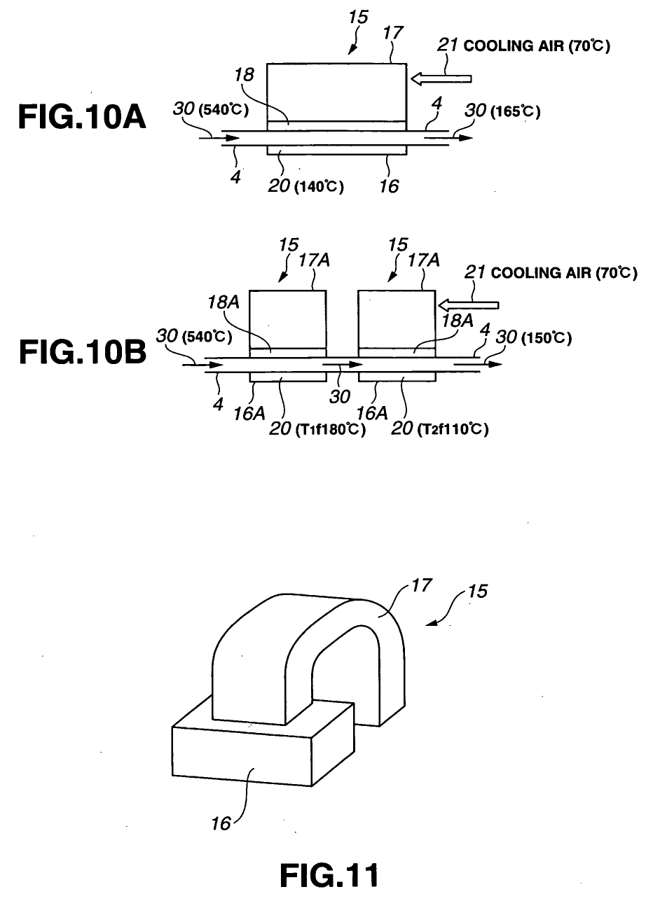

1. A cooling apparatus for a fluid, comprising:
an endoergic-side heat exchanger that has a fluid passage for passing a fluid to be cooled and stores a cooling medium for cooling the fluid through heat exchange with the fluid in the fluid passage;
an exoergic-side heat exchanger that has at least two cooling medium passages, one ends of the at least two cooling medium passages being communicated with the endoergic-side heat exchanger and the other ends of the at least two cooling medium passages being communicated with each other; and
cooling means that cools the cooling medium passing through the exoergic-side heat exchanger by heat exchange with the cooling medium,
wherein the cooling apparatus is configured so as to recirculate the cooling medium between the endoergic-side heat exchanger and the exoergic-side heat exchanger,
the cooling medium passages have a passage diameter or an equivalent diameter ranging from 2 mm to 16 mm, and
all the cooling medium passages are formed with a substantially equal diameter or the equivalent diameter.

2. The cooling apparatus for the fluid according to claim 1, wherein
an EGR passage that supplies an exhaust gas in an engine exhaust gas passage to an intake passage is provided, and
the exhaust gas passing through the EGR passage passes through the endoergic-side heat exchanger as the fluid to be cooled.

3. The cooling apparatus for the fluid according to claim 1, wherein
a turbocharger that compresses an intake air and introduces the compressed intake air to an engine intake air passage is provided, and
the intake air compressed by the turbocharger passes through the endoergic-side heat exchanger as the fluid to be cooled.

4. The cooling apparatus for the fluid according to claim 1, wherein the cooling means is a cooling fan.

5. The cooling apparatus for the fluid according to claim 4, further comprising:
a radiator through which an engine coolant passes; and
a radiator cooling fan, wherein
the radiator cooling fan is employed as the cooling means.

6. The cooling apparatus for the fluid according to claim 1, wherein
a ratio of a volume of the cooling medium to a total volume of the endoergic-side heat exchanger and the exoergic-side heat exchanger is set to a predetermined volume ratio ranging from 20% to 80%.

7. The cooling apparatus for the fluid according to claim 1, wherein the cooling apparatus comprises:
a plurality of separate endoergic-side heat exchangers;
a plurality of separate exoergic-side heat exchangers each corresponding to each of the plurality of separate endoergic-side heat exchangers, and wherein
the fluid passages in the plurality of separate endoergic-side heat exchangers are each communicated in series, and
a boiling point of the cooling medium in each of the plurality of separate endoergic-side heat exchangers is set so as to gradually decrease from an upper stream to a down stream of each of the fluid passages.

8. The cooling apparatus for the fluid according to claim 7, wherein
each of the plural separate endoergic-side heat exchangers is divided by a partition that allows the fluid to be cooled to pass to an adjoining endoergic-side heat exchanger and does not allow the cooling medium to pass to the adjoining endoergic-side heat exchanger.

9. The cooling apparatus for the fluid according to claim 4, further comprising:
a radiator through which an engine coolant passes; and
a radiator cooling fan, wherein
the cooling fan is provided as the cooling means separately from the radiator cooling fan.

10. The cooling apparatus for the fluid according to claim 4, wherein
the exoergic-side heat exchanger is formed in an annular shape, and
the cooling fan is arranged as the cooling means inside the exoergic-side heat exchanger formed in the annular shape.

11. The cooling apparatus for the fluid according to claim 10, wherein
the cooling apparatus is placed above the engine.

12. A cooling apparatus for a fluid, comprising:
an endoergic-side heat exchanger that has a fluid passage for passing the fluid to be cooled and stores a cooling medium for cooling the fluid through heat exchange with the fluid in the fluid passage;
an exoergic-side heat exchanger that has at least two cooling medium passages, one ends of the at least two cooling medium passages being communicated with the endoergic-side heat exchanger and the other ends of the at least two cooling medium passages being communicated with each other; and
cooling means that cools the cooling medium passing through the exoergic-side heat exchanger by heat exchange with the cooling medium,
wherein the cooling apparatus is configured so as to recirculate the cooling medium between the endoergic-side heat exchanger and the exoergic-side heat exchanger, and
the cooling medium passages are capable of passing steam vaporized from the cooling medium in the endoergic-side heat exchanger by absorbing heat of the fluid, and the cooling medium that becomes liquid in the exoergic-side heat exchanger after heat is absorbed with the cooling means.

13. The cooling apparatus for the fluid according to claim 2, wherein the cooling means is a cooling fan.

14. The cooling apparatus for the fluid according to claim 3, wherein the cooling means is a cooling fan.
